(19) United States
(12) Patent Application Publication
(10) Pub. No.: US 2009/0254403 A1
(43) Pub. Date: Oct. 8, 2009

(54) Line maintenance manager

(75) Inventors: Dinakara Nagalla, Woodbury, MN (US); Kevin Stoltzfus, Barnum, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Sinex Aviation Technologies, Duluth, MN (US)

(21) Appl. No.: 12/080,901

(22) Filed: Apr. 7, 2008

(51) Int. Cl. G06Q 10/00

(52) U.S. Cl. 705/9; 705/8

(57) ABSTRACT

A computer implemented method of managing execution of line maintenance for an aircraft includes creating an electronic scheduled bill of work comprising a plurality of planned tasks, creating an electronic work-in-progress bill of work comprising the scheduled bill of work and a plurality of unplanned tasks, electronically validating performance for each of the tasks in the work-in-progress bill of work, and creating an electronic maintenance release for the aircraft.

### BACKGROUND

The present invention relates to the field of maintenance. More specifically, the present invention relates to a system for and method of managing line maintenance for an aircraft.

Aircraft maintenance occupies a key position in airline operation because such maintenance is essential to the safety of passengers and the reliability of airline schedules. Each aircraft has its own maintenance requirements which are designed to keep the aircraft in an airworthy condition. These aircraft maintenance requirements typically originate from the aircraft's manufacturer, and can be revised throughout the life of the aircraft by the aircraft manufactures, the Federal Aviation Administration (FAA) and/or the Maintenance Review Board (MRB). Additionally, maintenance personnel may, under certain circumstances, change the schedule of these requirements by “escalating” or extending the interval at which a maintenance task is accomplished.

These aircraft maintenance requirements are documented in aircraft-specific MRB documents. An MRB document details each task that must be accomplished on a particular aircraft, the requirements of that task, and the frequency with which the task must be performed. The MRB document includes tasks that need to be accomplished anywhere from once a day to once every 20 years, as well as tasks that need to be accomplished after the aircraft has achieved a specific number of flight hours, flight cycles or other triggering aircraft use metrics. For most major aircraft types, the MRB document lists somewhere between 800 to 2,000 different tasks.

The MRB document details a very complicated maintenance schedule. To ensure compliance with the MRB document, airlines must implement various tracking programs to monitor for the dates when tasks come due, as well as to log the completion of those tasks and any corrective actions taken.

Because an aircraft produces revenue only when it is flying, it is essential for airline management to keep maintenance time at a minimum. Thus, airlines commonly group tasks together (into letter-checks) rather than perform the tasks one at a time as they come due. Letter checks commonly include “A checks”, “B checks”, “C checks” and “D checks”, with A checks occurring most frequently and having the fewest number of tasks. A and B checks typically can be performed overnight in a “line maintenance” environment, in which, assuming no complications arise, the aircraft typically loses little or no flight time. In this environment, the aircraft remains airworthy because it can be reassembled quickly. Conversely, C and D checks comprise a greater number of tasks, many of which require a substantial amount of time to complete. Thus C and D checks are typically performed in a heavy maintenance environment in which the aircraft is taken out of service. In this environment, an aircraft is taken into a hangar, where it is taken apart, inspected, fixed and reassembled during the course of one week to over a month.

Line maintenance, versus heavy maintenance, presents unique challenges to ensure the aircraft remains in service or is delayed from service as little as possible. Generally speaking, line maintenance consists of a number of planned maintenance tasks and a number of unplanned maintenance tasks, both of which may include routine and non-routine tasks (those not detailed in the MRB document). Planned maintenance tasks are those tasks that may be scheduled ahead of performing the line maintenance on the aircraft, such as the A and B letter checks discussed above. In addition to planned tasks, line maintenance includes unplanned maintenance tasks that arise just prior to or during the execution of line maintenance on the aircraft. As the name implies, unplanned tasks cannot be scheduled because they arise dynamically in the line maintenance environment. Although line maintenance can plan for a certain number of unplanned events, for example by estimating based on historical data for the aircraft, such unplanned maintenance tasks may nevertheless cause costly delays to the aircraft line maintenance if not handled quickly and efficiently. A need exists for a computer-based method and system to manage execution of line maintenance including planned and unplanned maintenance tasks performed on an aircraft without removing the aircraft from service.

### SUMMARY

A computer implemented method of managing execution of line maintenance for an aircraft includes creating an electronic scheduled bill of work comprising a plurality of planned tasks, creating an electronic work-in-progress bill of work comprising the scheduled bill of work and a plurality of unplanned tasks, electronically validating performance for each of the tasks in the work-in-progress bill of work, and creating an electronic maintenance release for the aircraft.

### BRIEF DESCRIPTION OF THE DRAWINGS

FIG. 1 is an architectural diagram illustrating a line maintenance management system according to the present invention.

FIG. 2 is a flow chart illustrating functions carried out by the line maintenance management system illustrated in FIG. 1.

FIG. 3 is a diagram illustrating an embodiment of the line maintenance management system of FIG. 1.

FIG. 4 is a schematic diagram illustrating a distributed computing network configured to store and process the line maintenance management system illustrated in FIGS. 1-3.

### DETAILED DESCRIPTION

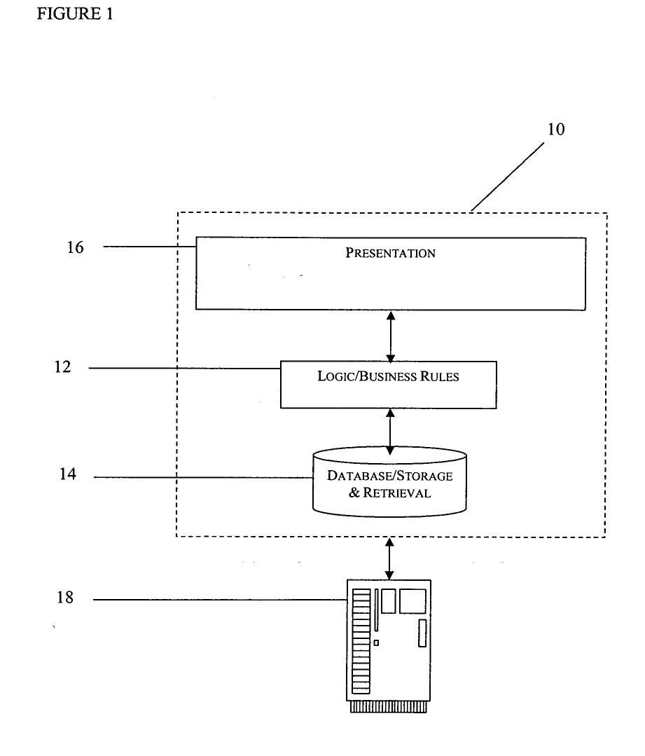

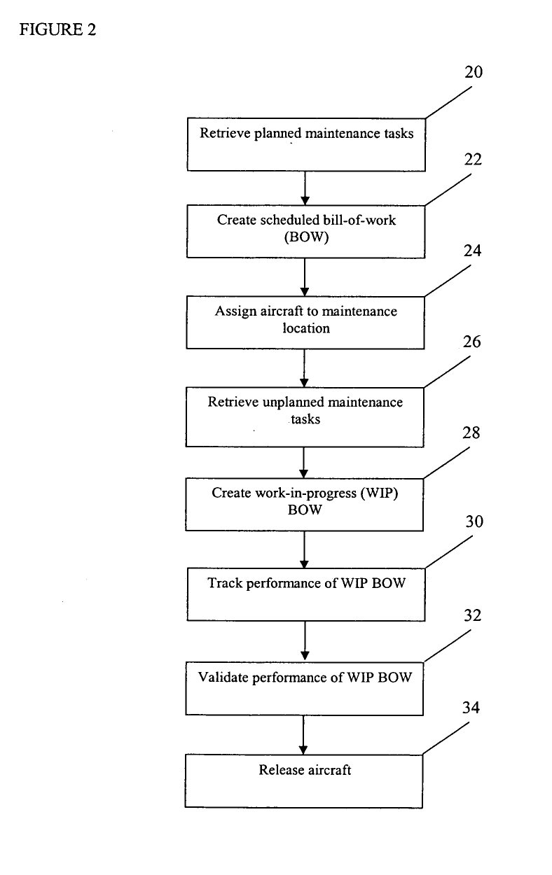

FIG. 1 is an architectural diagram illustrating line maintenance management system 10 according to the present invention, which system includes logic layer 12, database layer 14, and presentation layer 16. System 10 includes logic layer 12, which may include one or more software programs, components, stored procedures, etc. configured to implement business rules related to managing line maintenance of an aircraft. Communicating data necessary for system 10 to and from logic layer 12, and in some embodiments to presentation layer 16, is database layer 14. Database layer 14 may include off-the-shelf or proprietary databases or any other storage and retrieval mechanisms appropriate for use with system 10. Presentation layer 16 may include one or more interfaces, such as a graphical user interface (GUI), configured for user interaction with system 10. Presentation layer 16 may be configured for user interaction through, for example, operating system applications, such as a Microsoft Windows type application, and through applications configured to run in a web browser, such as Microsoft Internet Explorer, Netscape Navigator, Apple Safari, or Mozilla Firefox. Line maintenance management system 10 may be a stand-alone system configured to carry out methods according to the present invention (described in detail with reference to FIG. 2 below) for managing execution of line maintenance for an aircraft, or may be configured to interface with one or more external systems 18, which may include one or more electronic systems external to system 10, such as personnel training records and a maintenance documents repository.

FIG. 2 is a flow chart illustrating functions carried out by line maintenance management system 10 shown in FIG. 1, which functions include retrieving planned maintenance tasks for the aircraft (step 20), creating a scheduled bill of work including the planned tasks (step 22), assigning the aircraft to a maintenance location (step 24), retrieving unplanned maintenance tasks for the aircraft (step 26), creating a work-in-progress bill of work including the scheduled bill of work and the unplanned tasks (step 28), tracking performance of the tasks in the work-in-progress bill of work (step 30), validating performance for each of the tasks in the work-in-progress bill of work (step 32), and releasing the aircraft from line maintenance to flight status (step 34).

System 10 shown in FIG. 1 is capable of carrying out functions for retrieving a plurality of planned maintenance tasks for the aircraft (step 20) on which the line maintenance will be performed. Planned maintenance tasks may include, for example, scheduled inspections, letter checks, part changes, deferred discrepancies, deferred flight attendant logs, and deferred faults from electronic test controls on board the aircraft. Retrieving planned maintenance tasks (step 20) may include retrieving tasks from electronic sources included in or separate from system 10. For example, the planned maintenance tasks may be retrieved from a database, or another data storage and retrieval mechanism, populated with all of the relevant maintenance tasks for the aircraft. The database may include tasks from the MRB document, and airline and aircraft manufacturer maintenance records. The records forming the data stored in the database may be associated with the model type of the aircraft, as well as the particular aircraft on which line maintenance will be performed. The maintenance tasks may be stored in a single database or multiple legacy databases. For example, system 10 may retrieve the planned maintenance tasks (step 20) from an electronic version of the MRB document, as well as proprietary airline and aircraft manufacturer systems. The planned maintenance tasks may be retrieved (step 20) automatically, through user interaction, or a combination of both by, for example, querying the database for the relevant maintenance tasks appropriate for the particular aircraft on the day the line maintenance is to be performed.

In addition to retrieving planned maintenance tasks (step 20), system 10 may create a scheduled bill of work including the planned tasks (step 22). A “bill of work” as used herein is meant as any kind of sequential or ordered interactive electronic list or other collection, such as a table, of maintenance tasks. Each of the tasks in a bill of work may commonly include a plurality of data fields, such as estimated and actual completion time, which data fields may be edited by users of line maintenance management system 10. Creating a scheduled bill of work (step 22) may include prioritizing the planned tasks, estimating performance metrics for each of the planned tasks, and retrieving maintenance instructions associated with one or more of the planned tasks. System 10 may create the scheduled bill of work (step 22) by, for example, compiling all of the planned maintenance tasks retrieved for the aircraft (step 20) into an organized list. System 10 may then prioritize the planned tasks automatically, through user interaction, or a combination of both. Prioritizing the planned tasks in the scheduled bill of work may include analyzing task inter-dependencies, e.g. task A must be performed before task B, and maintenance personnel availability and training. After the planned tasks have been prioritized, performance metrics may be estimated for each of the tasks. For example, system 10 may estimate, automatically or through user interaction, the amount of time, number of personnel, and tooling and materials required to complete each of the tasks. Finally, system 10 may retrieve maintenance instructions for one or more of the planned maintenance tasks. Maintenance instructions may include step-by-step instructions for completing each of the tasks, which instructions may be used by maintenance personnel during line maintenance. The instructions may include a standard set of instructions drawn from, for example, the MRB document and manufacturer manuals, as well as maintenance personnel annotations collected during previous maintenance on the aircraft. The scheduled bill of work created (step 22) may therefore include, for example, a prioritized listing of the planned tasks with performance metric estimates and maintenance instructions associated with each of the tasks in the list.

System 10 may also assign the aircraft to a maintenance location (step 24). Assigning the aircraft to a maintenance location (step 24) may include assigning the aircraft to a station, i.e. a specific airport, and a hangar, ramp or gate at the station. System 10 may assign the maintenance location (step 24) by, for example, analyzing the aircraft's flight schedule to determine what stations the aircraft is passing through around the time the line maintenance is due. Additionally, system 10 may analyze each possible station's facility availability, e.g. how many gates or hangars are open for use, as well as the number, availability, and training levels of maintenance personnel at the station. Based on these and other factors, system 10 may optimally assign the maintenance location to, for example, minimize out of service time for the aircraft and maximize line maintenance efficiency.

In addition to assigning the aircraft to a maintenance location (step 24), system 10 may retrieve unplanned maintenance tasks for the aircraft (step 26). Aircraft line maintenance, as compared to heavy maintenance, includes not only planned tasks, but also unplanned maintenance tasks that arise dynamically in the line maintenance environment. Unplanned maintenance tasks arise in a number of different ways and include both routine and non-routine (e.g. tasks not included in the MRB document for the aircraft) type tasks. Non-routine tasks often arise during execution of a routine task mandated by the MRB document and therefore may be linked to the associated routine task. Unplanned maintenance tasks may include, for example, flight arrival pilot logs, flight arrival attendant logs, and faults from electronic test controls on board the aircraft. Retrieving unplanned maintenance tasks (step 26) may include retrieving tasks from electronic sources included in or separate from system 10. For example, the unplanned maintenance tasks may be retrieved (step 26) from a database, or another data storage and retrieval mechanism, automatically or manually populated with maintenance tasks arising just prior to or during the line maintenance on the aircraft. For example, one or more routine or non-routine maintenance tasks may be entered into system 10 from pilot and attendant logs upon arrival of the aircraft at the station at which line maintenance is performed. Alternatively, system 10 may, automatically or through user interaction, interface with the aircraft in flight through a wireless network connection to retrieve one or more faults generated by electronic test controls on board the aircraft, such as Built In Test Equipment (BITE) test faults.

System 10 may also create a work-in-progress bill of work including the scheduled bill of work and the unplanned tasks (step 28). Creating a work-in-progress bill of work (step 28) may include prioritizing the planned and unplanned tasks in the work-in-progress bill of work, assigning one or more maintenance personnel to the work-in-progress bill of work, ordering materials and tooling as necessary to execute the work-in-progress bill of work, retrieving maintenance instructions associated with one or more of the unplanned tasks, retrieving any new or updated maintenance instructions associated with one of more of the planned tasks, and requesting engineering resources and/or authorization to complete one or more of the tasks in the work-in-progress bill of work.

System 10 may create the work-in-progress bill of work (step 28) by, for example, compiling all of the planned maintenance tasks and the unplanned tasks retrieved for the aircraft (steps 20, 26) into an organized list. System 10 may then, automatically, through user interaction, or a combination of both, prioritize the planned and unplanned tasks. Prioritizing the planned and unplanned tasks in the work-in-progress bill of work may include analyzing task inter-dependencies, e.g. task A must be performed before task B, and maintenance personnel availability and training. After the planned tasks have been prioritized, maintenance personnel may be assigned to the work-in-progress bill of work. Maintenance personnel may be assigned individually or in groups to one or more of the planned and unplanned tasks in the work-in-progress bill of work. System 10 may assign maintenance personnel based on, for example, records of personnel availability and training. For example, system 10 may interface with one or more electronic systems including maintenance personnel schedules and training levels. Depending on the timing of the line maintenance and the required training level for completing the relevant task(s), system 10 may assign the appropriate maintenance personnel to the work-in-progress bill of work automatically or through user interaction.

In addition to assigning maintenance personnel, creating a work-in-progress bill of work (step 28) may include ordering materials and tooling as necessary to execute the work-in-progress bill of work. For example, automatically or through user interaction, system 10 may interface with one or more electronic systems to request and confirm availability of tooling and materials necessary to complete the planned and unplanned tasks in the work-in-progress bill of work. Ordering tooling and materials may include, for example, system 10 analyzing availability, costs, and locations of the necessary resources by interfacing with external customer and/or vendor systems. System 10 may also retrieve maintenance instructions for one or more of the unplanned maintenance tasks and retrieve any new or updated maintenance instructions for the planned tasks. Maintenance instructions may include step-by-step instructions for completing each of the tasks, which instructions may be used by maintenance personnel during line maintenance. The instructions may include a standard set of instructions drawn from, for example, the MRB document and manufacturer manuals, as well as maintenance personnel annotations collected during previous maintenance on the aircraft.

In addition to retrieving maintenance instructions, creating a work-in-progress bill of work (step 28) may include requesting engineering resources and/or authorization to complete one or more of the tasks in the work-in-progress bill of work. Completing one or more of the tasks in the work-in-progress may necessitate assistance from engineering, which request process is sometimes referred to as escalating the maintenance task. For example, engineering personnel may need to inspect damaged and/or repaired components, or the execution of a particular task may need to be authorized by engineering before beginning the work. In such cases, system 10 may request engineering resources, such as engineering personnel needed for an inspection, and/or engineering authorization, such as signing off on the performance of a maintenance task, by, for example, automatically or through user interaction contacting appropriate engineering personnel to perform the inspection or provide the authorization. For example, system 10 may send an electronic message to engineering requesting authorization of a repair to the aircraft. In response to the message sent by system 10, engineering personnel may authorize the repair by providing an electronic signature. System 10 may then indicate that the relevant task has been authorized and may store the electronic signature along with the authorized task.

In addition to creating a work-in-progress bill of work (step 28), system 10 may also track performance of the tasks in the work-in-progress bill of work (step 30). As maintenance personnel execute line maintenance on the aircraft, system 10 may act to electronically track performance of some or all of the tasks in the work-in-progress bill of work. For example, system 10 may store and automatically, or through user interaction track performance metrics associated with each of the tasks in the work-in-progress bill of work. Maintenance personnel may input progress on a task into system 10 by signing onto system 10 at the start of executing a task, as well as inputting, for example, completed steps in maintenance instructions for the task. In this way, system 10 may track, for example, what steps and how many steps have been completed for a task, approximate completion percentage, as well as comparing actual task performance data to task estimates like actual versus estimated completion time.

System 10 may also validate performance for each of the tasks in the work-in-progress bill of work (step 32). Validating performance for each of the tasks in the work-in-progress bill of work (step 32) may include validating completion of corrective actions and validating discrepancy deferrals for the maintenance tasks in the work-in-progress bill of work. In general, there are two possible resolutions to maintenance tasks during line maintenance: completing corrective actions, e.g. repairs or inspections, for the task, or deferring a discrepancy for later repair/completion. Some maintenance tasks involve non-critical components or systems on board the aircraft, or components or systems that do not absolutely require replacement, repair, or inspection at the time the line maintenance is scheduled but are nonetheless included in the work-in-progress bill of work for convenience or efficiency. Although these tasks may be included in the work-in-progress bill of work as a matter of course, the tasks may be deferred due to time constraints directed at completing the line maintenance without taking the aircraft out of service. For example, the work-in-progress bill of work may include tasks for replenishing in-flight beverages and food for passengers. However, in the event the needed supplies cannot be delivered in a timely manner or are not available at all, the tasks may be deferred for later completion.

The determination of whether to allow a discrepancy deferral may be based on business rules built into system 10, which may be used by system 10 to automatically or through user interaction allow or deny a discrepancy deferral for a maintenance task in the work-in-progress bill of work. For example, system 10 may include logic related to “aircraft on ground” (AOG) rules. AOG is an industry term indicating the highest priority designation given to maintenance tasks on an aircraft. An AOG designation for an aircraft indicates that a discrepancy is found that prevents returning the aircraft to service until the appropriate corrective action is taken. In either case of validating completion or a discrepancy deferral for a maintenance task, system 10 may validate performance (step 32) by receiving electronic signatures from maintenance personnel attesting to completion or deferral of the task. For example, a maintenance worker, such as a mechanic, may complete a line maintenance task on the aircraft and interact with system 10 to provide his electronic signature attesting to his completing the task. After the mechanic has signed off on the task, system 10 may require a second electronic signature from, for example, a supervisor to completely validate performance of the task (step 30). The work-in-progress bill of work including the status of each task as complete or deferred along with the electronic signatures and other data, such as performance metrics like estimated completion time and actual completion time, may be stored in system 10 or in an external database interoperable with system 10.

In addition to validating performance for each of the tasks in the work-in-progress bill of work (step 32), system 10 may include functions for creating a maintenance release for the aircraft (step 34). Creating a maintenance release for the aircraft (step 34) may include validating minimum airworthiness requirements for the aircraft, and creating a record of the work-in-progress bill of work including the maintenance personnel electronic signatures associated with the tasks in the work-in-progress bill of work. System 10 may release the aircraft from line maintenance to flight status by, for example, creating an electronic or paper maintenance release document. Creating the maintenance release for the aircraft (step 34) may include validating airworthiness requirements by, for example, checking the aircraft Minimum Equipment List (MEL) and Configuration Deviation List (CDL). The MEL and CDL are commonly used in the aircraft maintenance industry to determine the airworthiness of an aircraft before returning it to service. The MEL is derived from the Master Minimum Equipment List (MMEL), which is a listing of all equipment on the aircraft that has gone through the FAA development process and may include more items than are installed on the aircraft at any given time. The MEL is a list of instruments, equipment, and procedures that allow an aircraft to be airworthy with inoperative equipment. The CDL is a list of FAA-approved non-structural external parts that may be missing from the aircraft without taking the aircraft out of service. Before, after, or simultaneous with validating airworthiness requirements, system 10 may create a record of the work-in-progress bill of work. The work-in-progress bill of work record may be stored electronically in system 10, or may be exported for archival. For example, system 10 may export a paper copy of the closed work-in-progress bill of work including the maintenance tasks and associated data, such as performance metrics and maintenance personnel sign-offs gathered by electronic signature. Alternatively, system 10 may export the work-in-progress bill of work to an external database interoperable with system 10.

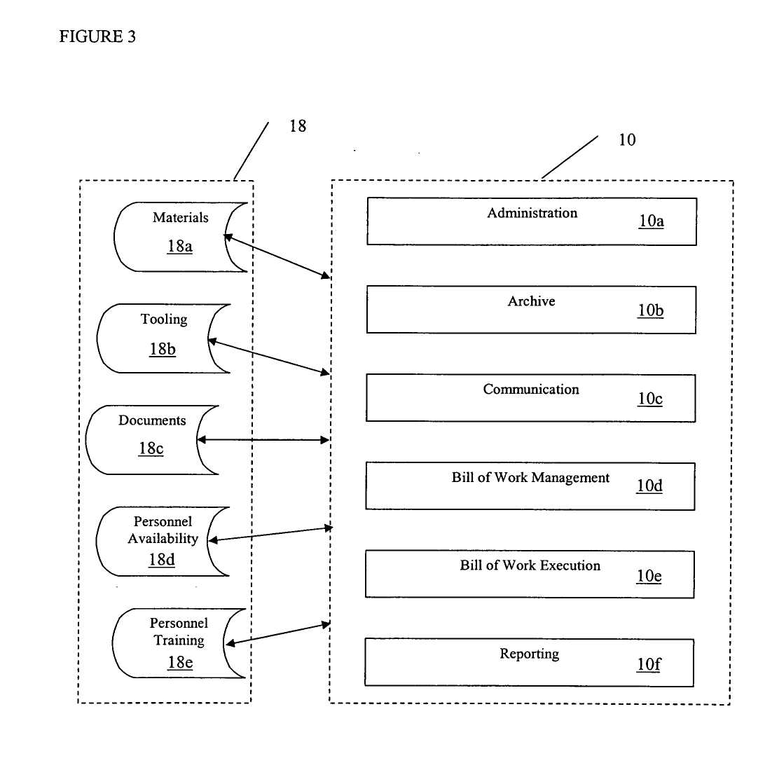

FIG. 3 is a diagram illustrating one implementation of line maintenance management system 10 of FIG. 1 including administration component 10a, archive component 10b, communications component 10c, bill of work management component 10d, bill of work execution component 10e, and reporting component 10f. In FIG. 3, line maintenance system 10 interfaces with a number of external electronic systems 18 including materials 18a, tooling 18b, documents 18c, personnel availability 18d, and personnel training 18e systems.

Administration component 10a may include functions for managing system security and permissions, business rules and standards, notifications, task authorizations, and system templates. Managing security and permissions may include, for example, configuring user permissions, creating, populating, and configuring permissions for user groups and roles (e.g. administrator and guest, and manager and mechanic respectively), managing usernames and passwords, and configuring database and file access and permissions. Managing business rules and standards may include, for example, managing aircraft MELs and CDLs and creating and editing AOG rules. Managing notifications may include creating and editing automatic system notifications triggered by system events. For example, an automatic notification may be created to request maintenance supervisor sign-off upon completion of a task by a mechanic. The notification may be associated with a general category of tasks or a specific task on a particular airplane. Managing task authorizations may include, for example, setting the sign-off procedure for general categories of tasks or specific tasks on a particular airplane. For example, certain groups of tasks may be validated by mechanic sign-off, while other tasks may require mechanic and supervisor sign-off to be validated. Finally, managing system templates may include, for example, creating and editing bill of work templates. Bill of work (scheduled and work-in-progress) templates may prescribe how tasks are categorized, such as replacement, repair, or inspection, and task attributes, such as performance metrics (e.g. estimated completion time, actual completion time, and required tooling and materials), training requirements, and frequency (flight cycles, flight hours, etc.). System templates may also include workflow documents graphically representing execution of line maintenance on an aircraft.

Archive component 10b includes functions for system data storage and retrieval. For example, archive component 10b may include one or more standard or proprietary electronic databases. System data stored in and retrieved from archive component 10b may include, for example, aircraft equipment warranty information that includes equipment warranty terms and actual equipment performance. Archived data may also include audit trails, which may include, for example, system events that cause data to be altered in a database and electronic signatures received for activities related to the airworthiness of an aircraft. Additionally, archive component 10b may store line maintenance bills of work (scheduled and work-in-progress) including maintenance personnel electronic signatures associated with the tasks in the bills of work.

Communications component 10c includes functions for managing internal and external system communications. For example, communications component 10c may manage messaging services between system users, such as an internal e-mail service. Additionally, communications component 10c may manage messaging or other communications with external electronic systems, such as delivering messages to external e-mail accounts and interfacing with external databases like maintenance materials and tooling systems 18a, 18b, document management system 18c, and maintenance personnel availability and training systems 18d, 18e. Communications component 10c may also include a system dictionary including a standard dictionary that may be augmented by specific industry and user terms, as well as system help functions to assist users in navigating and using the system.

Bill of work management component 10d includes functions for creating, editing, and deleting line maintenance bills of work (scheduled and work-in-progress). For example, bill of work management component 10d may enable users to initially define a scheduled bill of work including a list of planned maintenance tasks. Users may select a system bill of work template to initially define the scheduled bill of work and then may, if authorized, modify the template to complete definition of the particular scheduled bill of work. Users may facilitate or the system may automatically retrieve the planned maintenance tasks to be included in the scheduled bill of work. For example, the system may interface with an electronic version of the MRB document for the aircraft on which maintenance is scheduled to retrieve the maintenance tasks that are required for the aircraft. Users may enter performance metrics estimates for the tasks in the bill of work, such as the time, number of personnel, and tooling and materials required to complete the tasks. Alternatively, the system may automatically estimate the performance metrics based on historical data for the aircraft model or the particular aircraft on which maintenance is scheduled. As with the scheduled bill of work, bill of work management component 10d may enable users to create the work-in-progress bill of work by augmenting the scheduled bill of work with unplanned tasks retrieved from, for example, flight arrival pilot logs, flight arrival attendant logs, and BITE test faults.

Bill of work execution component 10e includes functions for managing execution of the work-in-progress bill of work during the aircraft line maintenance visit. For example, bill of work execution component 10e may include functions for identifying all of the data that must be captured to accomplish the bill of work in accordance with regulations and company policies and procedures. The required data fields may be prescribed by, for example, the bill of work templates created and managed using the administration component 10a. Bill of work execution component 10e may also provide a checklist of maintenance tasks that must be accomplished before releasing the aircraft and manage information sharing between users during line maintenance execution on the aircraft. Finally, bill of work execution component 10e may manage releasing the aircraft from line maintenance to flight status by, for example, allowing qualified users to document line maintenance completion after the system validates that all requirements have been satisfied, such as validating minimum airworthiness requirements by checking the aircraft MEL and CDL.

Reporting component 10f includes functions for creating, viewing, and editing electronic and paper reports related to management of the execution of line maintenance on an aircraft. For example, reporting component 10f may include status, performance, forecast and regulatory reports. Status reports may include the status of one or more stations, a fleet of aircraft or one particular aircraft, and bills of work, both planned and in progress. For example, a work-in-progress bill of work status report may present a user of the system, such as a manager, with a representation of the tasks completed, in progress, and pending on the work-in-progress bill of work, the time the aircraft has been in line maintenance, and estimated completion time versus actual time spent on individual tasks and the entire bill of work. Performance reports may include performance metrics for bills of work in progress or for previously completed bills of work, as well as other statistical reports, such as aircraft out of service (AOS) time for a single aircraft or averages for an entire fleet. For example, a performance report may include a graph of the average AOS time for a fleet of aircraft per month for a series of months. Forecast reports may include predictions about future line maintenance activities for a single or multiple aircraft, such as a report predicting out of service time for a particular aircraft for each month of a future year. Regulatory reports may include reports on MEL data, significant event data, and incident reports. Reporting component 10f may include standardized reports based on out of the box or customer defined templates, as well as functions for custom report creation.

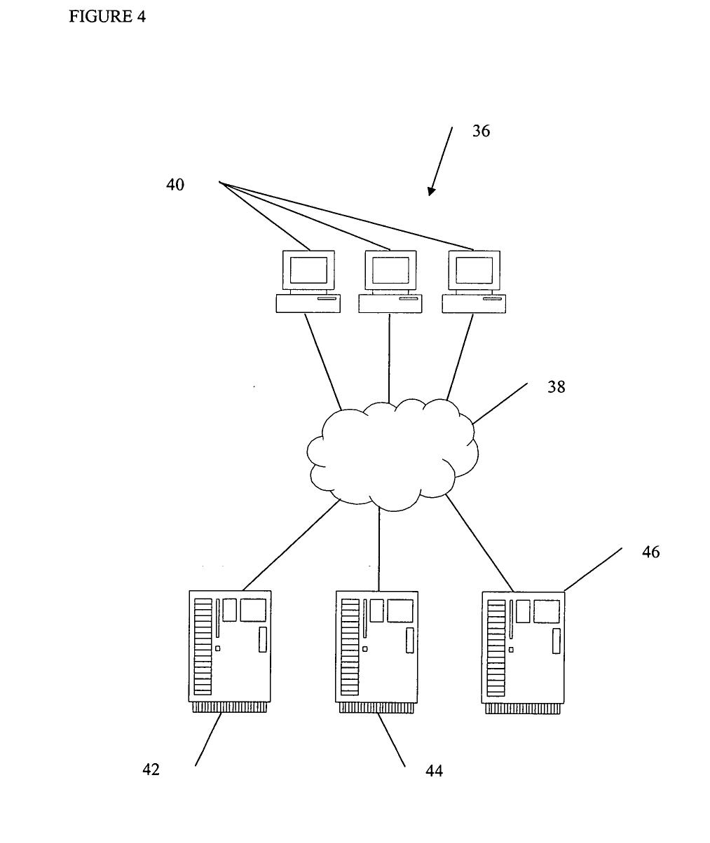

Line maintenance management system 10, and in some embodiments external systems 18, may be stored and processed on a single computer or may be distributed across more than one computer. For example, FIG. 4 is a schematic diagram illustrating a distributed computing network 36 configured to store and process line maintenance management system 10 and external systems 18. Computing network 36 includes network cloud 38, user terminals 40, first server 42, second server 44, and third server 46. Network cloud 38 may be a private or public network infrastructure, such as a corporate LAN or WAN or the Internet, configured to connect user terminals 40 and first, second, and third servers 42-46. Network cloud 38 may include wired and/or wireless connections configured to transmit data using one or more communications protocols, such as IP or ATM. Computing network 36 also includes user terminals 40 through which one or more users may access and use line maintenance management system 10. User terminals 40 each may include, for example, a computer configured with an operating system, such as Windows, Macintosh, or LINUX, a monitor, and input devices, such as a keyboard, a mouse, a stylus or some combination thereof. User terminals 40 may include desktop or laptop computers, as well as handheld devices, such as a Personal Data Assistant (PDA). Computing network 36 includes first, second, and third servers 42-46, which may be, for example, configured to store and process line maintenance management system 10 and two external systems 18 respectively.

Line maintenance is a critical component of airline operation. Increases in aircraft out of service time caused by delays and inefficiencies in the line maintenance environment carry costly penalties for airlines. It is therefore critical to increase the quality and efficiency of conducting line maintenance on not only individual aircraft but across the airline's entire fleet. Embodiments of the present invention provide methods of and systems for managing execution of line maintenance on an aircraft. Line maintenance management methods and systems according to the present invention substantially increase the efficiency of current airline procedures and improve access to and visibility of important aircraft maintenance data for individual aircraft and across an entire fleet of aircraft, while simultaneously remaining compliant with stringent regulatory requirements incumbent on airlines. Methods and systems according to the present invention account for the unique planned and dynamic nature of aircraft line maintenance execution and deliver management solutions from maintenance scheduling through aircraft release back to flight status.

Although the present invention has been described with reference to preferred embodiments, workers skilled in the art will recognize that changes may be made in form and detail without departing from the spirit and scope of the invention.

1. A computer implemented method of managing execution of line maintenance for an aircraft, the method comprising:
creating an electronic scheduled bill of work comprising a plurality of planned tasks;
creating an electronic work-in-progress bill of work comprising the scheduled bill of work and a plurality of unplanned tasks;
electronically validating performance for each of the tasks in the work-in-progress bill of work; and
creating an electronic maintenance release for the aircraft.

2. The method of claim 1 further comprising retrieving the planned maintenance tasks for the aircraft.

3. The method of claim 2, wherein one or more of the planned tasks are electronically imported from one or more electronic systems.

4. The method of claim 2, wherein one or more of the planned tasks are electronically inputted by one or more maintenance personnel.

5. The method of claim 1, wherein the planned tasks comprise one or more of scheduled inspections, letter checks, part changes, deferred discrepancies, deferred flight attendant logs, and deferred faults from electronic test controls on board the aircraft.

6. The method of claim 1, wherein creating the electronic scheduled bill of work comprises:
prioritizing the planned tasks; and
estimating one or more performance metrics for each of the planned tasks.

7. The method of claim 6, wherein the performance metrics comprise one or more of a completion time, a number of maintenance personnel, and required tooling and materials.

8. The method of claim 6 further comprising retrieving electronic maintenance instructions associated with one or more of the planned tasks.

9. The method of claim 1 further comprising electronically assigning the aircraft to a maintenance location.

10. The method of claim 9, wherein the maintenance location comprises a station and a hangar, a ramp, or a gate.

11. The method of claim 1 further comprising retrieving the unplanned maintenance tasks for the aircraft.

12. The method of claim 11, wherein one or more of the unplanned tasks are retrieved from the aircraft in flight through a wireless network connection.

13. The method of claim 11, wherein one or more of the unplanned tasks are electronically imported from one or more electronic systems.

14. The method of claim 11, wherein one or more of the unplanned tasks are electronically inputted by one or more maintenance personnel.

15. The method of claim 1, wherein the unplanned tasks comprise one or more of flight arrival pilot logs, flight arrival attendant logs, and faults from electronic test controls on board the aircraft.

16. The method of claim 1, wherein creating the electronic work-in-progress bill of work comprises:
prioritizing the planned and unplanned tasks in the work-in-progress bill of work;
assigning one or more maintenance personnel to the work-in-progress bill of work; and
ordering materials and tooling as necessary to execute the work-in-progress bill of work.

17. The method of claim 16, wherein the maintenance personnel are assigned to the work-in-progress bill of work by analyzing electronic availability and training records.

18. The method of claim 16 further comprising retrieving electronic maintenance instructions associated with one or more of the unplanned tasks.

19. The method of claim 16 further comprising retrieving any new or updated electronic maintenance instructions associated with one of more of the planned tasks.

20. The method of claim 16 further comprising electronically requesting engineering resources as necessary to complete one or more of the tasks in the work-in-progress bill of work.

21. The method of claim 16 further comprising electronically requesting engineering authorization to complete one or more of the tasks in the work-in-progress bill of work.

22. The method of claim 1 further comprising electronically tracking performance of the tasks in the work-in-progress bill of work.

23. The method of claim 1, wherein electronically validating performance for each of the tasks in the work-in-progress bill of work comprises electronically validating completion or a discrepancy deferral for each of the tasks in the work-in-progress bill of work.

24. The method of claim 23, wherein electronically validating completion or a discrepancy deferral for each of the tasks in the work-in-progress bill of work comprises receiving one or more electronic signatures from one or more maintenance personnel assigned to the work-in-progress bill of work.

25. The method of claim 1 further comprising:
retrieving electronic availability and training records for one or more maintenance personnel; and
automatically assigning the maintenance personnel to the electronic work-in-progress bill of work based on the electronic availability and training records retrieved.

26. The method of claim 1, wherein creating an electronic maintenance release for the aircraft comprises:
electronically validating one or more airworthiness requirements for the aircraft; and
creating a record of the electronic work-in-progress bill of work and one or more electronic signatures of one or more maintenance personnel assigned to the work-in-progress bill of work.

27. An electronic system for managing execution of line maintenance for an aircraft, the system comprising:
at least one computer comprising one or more programs configured to:
create a scheduled bill of work comprising a plurality of planned tasks;
create a work-in-progress bill of work comprising the scheduled bill of work and a plurality of unplanned tasks;
validate performance for each of the tasks in the work-in-progress bill of work; and
create a maintenance release for the aircraft.

28. The system of claim 27, wherein the programs are configured to retrieve the planned maintenance tasks for the aircraft.

29. The system of claim 27, wherein the planned tasks comprise one or more of scheduled inspections, letter checks, part changes, deferred discrepancies, deferred flight attendant logs, and deferred faults from electronic test controls on board the aircraft.

30. The system of claim 27, wherein creating the scheduled bill of work comprises:
prioritizing the planned tasks; and
estimating one or more performance metrics for each of the planned tasks.

31. The system of claim 30, wherein the performance metrics comprise one or more of a completion time, a number of maintenance personnel, and required tooling and materials.

32. The system of claim 30 further comprising retrieving electronic maintenance instructions associated with one or more of the planned tasks.

33. The system of claim 27, wherein the programs are configured to assign the aircraft to a maintenance location.

34. The system of claim 27, wherein the programs are configured to retrieve the unplanned maintenance tasks for the aircraft.

35. The system of claim 27, wherein the unplanned tasks comprise one or more of flight arrival pilot logs, flight arrival attendant logs, and faults from electronic test controls on board the aircraft.

36. The system of claim 27, wherein creating the work-in-progress bill of work comprises:
prioritizing the planned and unplanned tasks in the work-in-progress bill of work;
assigning one or more maintenance personnel to the work-in-progress bill of work; and
ordering materials and tooling as necessary to execute the work-in-progress bill of work.

37. The system of claim 36, wherein the maintenance personnel are assigned to the work-in-progress bill of work by analyzing electronic availability and training records.

38. The system of claim 36 further comprising retrieving electronic maintenance instructions associated with one or more of the unplanned tasks.

39. The system of claim 36 further comprising retrieving any new or updated electronic maintenance instructions associated with one of more of the planned tasks.

40. The system of claim 36 further comprising requesting engineering resources as necessary to complete one or more of the tasks in the work-in-progress bill of work.

41. The system of claim 36 further comprising requesting engineering authorization to complete one or more of the tasks in the work-in-progress bill of work.

42. The system of claim 27, wherein the programs are configured to track performance of the tasks in the work-in-progress bill of work.

43. The system of claim 27, wherein validating performance for each of the tasks in the work-in-progress bill of work comprises validating completion or a discrepancy deferral for each of the tasks in the work-in-progress bill of work.

44. The system of claim 43, wherein validating completion or a discrepancy deferral for each of the tasks in the work-in-progress bill of work comprises receiving one or more electronic signatures from one or more maintenance personnel assigned to the work-in-progress bill of work.

45. The system of claim 27, wherein creating a maintenance release for the aircraft comprises:
validating one or more airworthiness requirements for the aircraft; and
creating a record of the electronic work-in-progress bill of work and one or more electronic signatures of one or more maintenance personnel assigned to the work-in-progress bill of work.
